(19) United States
(12) Patent Application Publication
(10) Pub. No.: US 2011/0196125 A1
(43) Pub. Date: Aug. 11, 2011

(54) Degradable Polymers for Hydrocarbon Extraction

(75) Inventor: Steven R. Wann, Bainbridge, GA (US)

(73) Assignee: DANIMER SCIENTIFIC, LLC, Bainbridge, GA (US)

(21) Appl. No.: 12/917,538

(22) Filed: Nov. 2, 2010

Related U.S. Application Data
(60) Provisional application No. 61/302,257, filed on Feb. 8, 2010.

(51) Int. Cl. C08G 63/06; C08G 63/08

(52) U.S. Cl. 528/354; 528/361

(57) ABSTRACT

The present disclosure is directed degradable polymers. The polymers are solid when maintained under substantially dry conditions at a temperature of up to about 90 degrees C. When contacted with water at a temperature of up to about 90 degrees C., however, the polymers initially remain solid for a period of up to about 6 to about 24 hours, then depolymerize to provide a liquid having a viscosity of from about 1 to about 200,000 centipoise after a period of time from about 8 hours to about 3 days and then further depolymerizes to water-soluble components after a period of time at least about 3 days. Also disclosed are sand screen coatings made with the polymers and hydraulic and acid fracturing methods using the polymers.

### CROSS-REFERENCE TO RELATED APPLICATIONS

This application claims the benefit of the earlier filing date of provisional application No. 61/302,257, filed Feb. 8, 2010.

### FIELD

The present disclosure relates in general to the preparation or completion of petroleum wells, and in particular, to the use of degradable polymeric materials during the preparation or completion of petroleum wells.

### BACKGROUND

Before commercial quantities of petroleum and/or other hydrocarbons can be extracted from a well, the well must typically be prepared in process known as well completion. Well completion may include hydraulic fracturing or acid etching of the subterranean rock formation adjacent the well bore in order to improve the permeability of the formation. Well completion may also include the installation of perforated piping and/or sand screens within the well. Valves and other downhole tools may also be installed.

In many instances, it may be desirable that certain downhole tools are only installed on a temporary basis. Likewise, it may be desirable to apply a temporary covering over sand screens or perforated piping so that the holes in the screen or piping do not become clogged with dirt or debris during the initial installation of the screen or perforated piping within the well.

It would therefore be advantageous to fabricate downhole tools, sand screen covering, and the like from polymeric materials which are initially solid, but which can be readily induced to decompose into substantially liquid compositions under conditions commonly encountered within petroleum wells. Polymeric material which would decompose into substantially liquid compositions, leaving no solid residue, in a period of a few days would be particularly advantageous. It would also be advantageous to employ such materials during the fracturing or etching of subterranean rock formations.

### SUMMARY

### Degradable Polymer Composition

In a first aspect, the present disclosure provides a composition which includes at least one degradable polymer. According to one embodiment, the degradable polymer is a solid when maintained under substantially dry conditions at a temperature of up to about 90 degrees C. When the degradable polymer is contacted with water at a temperature of up to about 90 degrees C., the degradable polymer initially remains solid for a period of up to about 6 to about 24 hours, then depolymerizes to provide a liquid having a viscosity of from about 1 to about 200,000 centipoise after a period of time from about 8 hours to about 3 days and then further depolymerizes to water-soluble components after a period of time at least about 3 days.

According to certain embodiments of the present disclosure, the at least one degradable polymer preferably includes: (1) from about 20 to about 80 mole percent monomer residues of a first monomer selected from the group consisting of L-lactic acid, D-lactic acid, L-lactide, D-lactide, and glycolic acid; (2) from about 20 to about 80 mole percent monomer residues of a second monomer, which is different from the first monomer, selected from the group consisting of L-lactic acid, D-lactic acid, L-lactide, D-lactide, and glycolic acid; and (3) from about 0.001 to about 32 mole percent monomer residues of at least one compound which is capable of reacting with either the first monomer or the second monomer to form an ester.

In some embodiments of the present disclosure, the at least one compound which is capable of reacting with either the first monomer or the second monomer to form an ester preferably is selected from the group consisting of (i) a monofunctional or multifunctional alcohol; (ii) a monofunctional or multifunctional carboxylic acid; (iii) an anhydride that yields a monofunctional or multifunctional carboxylic acid upon reaction of the anhydride; and (iv) a monofunctional or multifunctional epoxide.

In certain embodiments of the present disclosure, the first monomer is preferably L-lactic acid, and the second monomer is glycolic acid. The degradable polymer preferably includes from about 70 to about 80 mole percent monomer residues of the first monomer and from about 20 to about 30 mole percent monomer residues of the second monomer.

In certain other embodiments of the present disclosure, the first monomer is preferably L-lactic acid, and the second monomer is D-lactic acid. The degradable polymer preferably includes from about 70 to about 80 mole percent monomer residues of the first monomer and from about 20 to about 30 mole percent monomer residues of the second monomer.

In still other embodiments of the present disclosure, the first monomer is preferably L-lactide, and the second monomer is D-lactide. The degradable polymer preferably includes from about 50 to about 99.5 mole percent monomer residues of the first monomer and from about 0.5 to about 50 mole percent monomer residues of the second monomer.

In some instances, the composition may include a blend of two or more of the aforementioned degradable polymers. Further, according to some embodiments, the composition may also include up to about 5 weight percent of polylactic acid having a number average molecular weight of greater than about 25,000.

In certain other embodiments of the present disclosure, the at least one compound which is capable of reacting with either the first monomer or the second monomer to form an ester is preferably selected from the group consisting of (i) a monofunctional or multifunctional alcohol having from 1 to 16 hydroxyl groups; (ii) a monofunctional or multifunctional carboxylic acid having from 1 to 16 carboxylic acid groups; (iii) and an anhydride that yields a monofunctional or multifunctional carboxylic acid having from 2 to 16 carboxylic acid groups upon reaction of the anhydride.

In certain other embodiments of the present disclosure, the at least one compound which is capable of reacting with either the first monomer or the second monomer to form an ester includes a multifunctional alcohol selected from the group consisting of pentaerythritol, glycerine, 1,3-propanediol, 1,4-butanediol, 1,6-hexanediol, trimethyolpropane, dendritic polyols having up to 16 hydroxyl groups, dipentaerythritol, and mixtures thereof.

In one embodiment of the present disclosure, the at least one compound which is capable of reacting with either the first monomer or the second monomer to form an ester preferably includes a polymer, such as a polyvinyl alcohol or a polyacrylic acid.

In another embodiment of the present disclosure, the at least one compound which is capable of reacting with either the first monomer or the second monomer to form an ester preferably includes pentaerythritol.

In still another embodiment of the present disclosure, the at least one compound which is capable of reacting with either the first monomer or the second monomer to form an ester preferably includes a multifunctional carboxylic acid selected from the group consisting of adipic acid, succinic acid, sebacic acid, and mixtures thereof.

In yet another embodiment of the present disclosure, the at least one compound which is capable of reacting with either the first monomer or the second monomer to form an ester preferably includes a cyclic anhydride that yields a multifunctional carboxylic acid selected from the group consisting of trimellitic anhydride, pyromellitic anhydride, and mixtures thereof.

According to certain embodiments of the present disclosure, the degradable copolymer preferably has a number average molecular weight of from about 3000 to about 22,000. In certain embodiments, it is also preferred that the degradable copolymer has a polydispersity index of from about 1.0 up to about 3.0.

Further, in certain embodiments, the present disclosure provides a degradable downhole tool for use in a wellbore, wherein the downhole tool is made of the degradable composition described above. For instance, in one embodiment, the degradable downhole tool may include a fluid diverter. In another embodiment, the degradable downhole tool may include a valve. In another embodiment, the degradable downhole tool may include a plug.

Screen Coating

In a second aspect, the present disclosure provides a method for installing a perforated screen or liner within a well. According to one embodiment, the method includes the steps of: coating the perforated screen or liner with at least one degradable polymer; positioning the now-coated perforated screen or liner within a subterranean well hole; and depolymerizing the at least one degradable polymer into water-soluble components thereby removing the coating on the perforated screen or liner.

In certain embodiments of the present disclosure, the step of depolymerizing the at least one degradable polymer preferably include contacting the degradable polymer with water in the well at a temperature from about 50 degrees F. to about 90 degrees F. for a period of time of at least about 3 days.

According to certain embodiments of the present disclosure, the at least one degradable polymer is a solid when maintained under substantially dry conditions at a temperature of up to about 90 degrees C. When the degradable polymer is contacted with water at a temperature of up to about 90 degrees C., the degradable polymer initially remains solid for a period of up to about 6 to about 24 hours, then depolymerizes to provide a liquid having a viscosity of from about 1 to about 200,000 centipoise after a period of time from about 8 hours to about 3 days and then further depolymerizes to water-soluble components after a period of time at least about 3 days.

According to certain embodiments of the present disclosure, the at least one degradable polymer preferably includes: (1) from about 20 to about 80 mole percent monomer residues of a first monomer selected from the group consisting of L-lactic acid, D-lactic acid, L-lactide, D-lactide, and glycolic acid; (2) from about 20 to about 80 mole percent monomer residues of a second monomer, which is different from the first monomer, selected from the group consisting of L-lactic acid, D-lactic acid, L-lactide, D-lactide, and glycolic acid; and (3) from about 0.001 to about 32 mole percent monomer residues of at least one compound which is capable of reacting with either the first monomer or the second monomer to form an ester.

In some embodiments of the present disclosure, the at least one compound which is capable of reacting with either the first monomer or the second monomer to form an ester preferably is selected from the group consisting of (i) a monofunctional or multifunctional alcohol; (ii) a monofunctional or multifunctional carboxylic acid; (iii) an anhydride that yields a monofunctional or multifunctional carboxylic acid upon reaction of the anhydride; and (iv) a monofunctional or multifunctional epoxide.

In certain embodiments of the present disclosure, the first monomer is preferably L-lactic acid, and the second monomer is glycolic acid. The degradable polymer preferably includes from about 70 to about 80 mole percent monomer residues of the first monomer and from about 20 to about 30 mole percent monomer residues of the second monomer.

In certain other embodiments of the present disclosure, the first monomer is preferably L-lactic acid, and the second monomer is D-lactic acid. The degradable polymer preferably includes from about 70 to about 80 mole percent monomer residues of the first monomer and from about 20 to about 30 mole percent monomer residues of the second monomer.

In still other embodiments of the present disclosure, the first monomer is preferably L-lactide, and the second monomer is D-lactide. The degradable polymer preferably includes from about 50 to about 99.5 mole percent monomer residues of the first monomer and from about 0.5 to about 50 mole percent monomer residues of the second monomer.

In some instances, the composition may include a blend of two or more of the aforementioned degradable polymers. Further, according to some embodiments, the composition may also include up to about 5 weight percent of polylactic acid having a number average molecular weight of greater than about 25,000.

In certain other embodiments of the present disclosure, the at least one compound which is capable of reacting with either the first monomer or the second monomer to form an ester is preferably selected from the group consisting of (i) a monofunctional or multifunctional alcohol having from 1 to 16 hydroxyl groups; (ii) a monofunctional or multifunctional carboxylic acid having from 1 to 16 carboxylic acid groups; (iii) and an anhydride that yields a monofunctional or multifunctional carboxylic acid having from 2 to 16 carboxylic acid groups upon reaction of the anhydride.

In certain other embodiments of the present disclosure, the at least one compound which is capable of reacting with either the first monomer or the second monomer to form an ester includes a multifunctional alcohol selected from the group consisting of pentaerythritol, glycerine, 1,3-propanediol, 1,4-butanediol, 1,6-hexanediol, trimethyolpropane, dendritic polyols having up to 16 hydroxyl groups, dipentaerythritol, and mixtures thereof.

In one embodiment of the present disclosure, the at least one compound which is capable of reacting with either the first monomer or the second monomer to form an ester preferably includes a polymer, such as a polyvinyl alcohol or a polyacrylic acid.

In another embodiment of the present disclosure, the at least one compound which is capable of reacting with either the first monomer or the second monomer to form an ester preferably includes pentaerythritol.

In still another embodiment of the present disclosure, the at least one compound which is capable of reacting with either the first monomer or the second monomer to form an ester preferably includes a multifunctional carboxylic acid selected from the group consisting of adipic acid, succinic acid, sebacic acid, and mixtures thereof.

In yet another embodiment of the present disclosure, the at least one compound which is capable of reacting with either the first monomer or the second monomer to form an ester preferably includes a cyclic anhydride that yields a multifunctional carboxylic acid selected from the group consisting of trimellitic anhydride, pyromellitic anhydride, and mixtures thereof.

According to certain embodiments of the present disclosure, the degradable copolymer preferably has a number average molecular weight of from about 3000 to about 22,000. In certain embodiments, it is also preferred that the degradable copolymer has a polydispersity index of from about 1.0 up to about 3.0.

Hydraulic Fracture

In an additional aspect, the present disclosure also provides a method for hydraulic fracturing of a subterranean rock formation adjacent a well borehole. According to one embodiment, the method includes a first step of mixing solid pellets with a pumpable fluid. The solid pellets are made up of at least one degradable polymer and a proppant dispersed within the degradable polymer. The fluid and the solid pellets mixed therein are pumped down the borehole and into the rock formation. The degradable polymer then partially depolymerizes into a viscous liquid having a viscosity of from about 1 to about 200,000 centipoise. Pressure is applied to the viscous liquid within the well borehole which is sufficient to induce fracturing of the adjacent rock formation and force both the viscous liquid and proppant dispersed therein into the resultant fractures. The viscous liquid then further depolymerizes into water-soluble components while leaving the proppant disposed with the fractures in the rock formation.

According to certain embodiments of the present disclosure, the at least one degradable polymer is a solid when maintained under substantially dry conditions at a temperature of up to about 90 degrees C. When the degradable polymer is contacted with water at a temperature of up to about 90 degrees C., the degradable polymer initially remains solid for a period of up to about 6 to about 24 hours, then depolymerizes to provide a liquid having a viscosity of from about 1 to about 200,000 centipoise after a period of time from about 8 hours to about 3 days and then further depolymerizes to water-soluble components after a period of time at least about 3 days.

According to certain embodiments of the present disclosure, the at least one degradable polymer preferably includes: (1) from about 20 to about 80 mole percent monomer residues of a first monomer selected from the group consisting of L-lactic acid, D-lactic acid, L-lactide, D-lactide, and glycolic acid; (2) from about 20 to about 80 mole percent monomer residues of a second monomer, which is different from the first monomer, selected from the group consisting of L-lactic acid, D-lactic acid, L-lactide, D-lactide, and glycolic acid; and (3) from about 0.001 to about 32 mole percent monomer residues of at least one compound which is capable of reacting with either the first monomer or the second monomer to form an ester.

In some embodiments of the present disclosure, the at least one compound which is capable of reacting with either the first monomer or the second monomer to form an ester preferably is selected from the group consisting of (i) a monofunctional or multifunctional alcohol; (ii) a monofunctional or multifunctional carboxylic acid; (iii) an anhydride that yields a monofunctional or multifunctional carboxylic acid upon reaction of the anhydride; and (iv) a monofunctional or multifunctional epoxide.

In certain embodiments of the present disclosure, the first monomer is preferably L-lactic acid, and the second monomer is glycolic acid. The degradable polymer preferably includes from about 70 to about 80 mole percent monomer residues of the first monomer and from about 20 to about 30 mole percent monomer residues of the second monomer.

In certain other embodiments of the present disclosure, the first monomer is preferably L-lactic acid, and the second monomer is D-lactic acid. The degradable polymer preferably includes from about 70 to about 80 mole percent monomer residues of the first monomer and from about 20 to about 30 mole percent monomer residues of the second monomer.

In still other embodiments of the present disclosure, the first monomer is preferably L-lactide, and the second monomer is D-lactide. The degradable polymer preferably includes from about 50 to about 99.5 mole percent monomer residues of the first monomer and from about 0.5 to about 50 mole percent monomer residues of the second monomer.

In some instances, the composition may include a blend of two or more of the aforementioned degradable polymers. Further, according to some embodiments, the composition may also include up to about 5 weight percent of polylactic acid having a number average molecular weight of greater than about 25,000.

In certain other embodiments of the present disclosure, the at least one compound which is capable of reacting with either the first monomer or the second monomer to form an ester is preferably selected from the group consisting of (i) a monofunctional or multifunctional alcohol having from 1 to 16 hydroxyl groups; (ii) a monofunctional or multifunctional carboxylic acid having from 1 to 16 carboxylic acid groups; (iii) and an anhydride that yields a monofunctional or multifunctional carboxylic acid having from 2 to 16 carboxylic acid groups upon reaction of the anhydride.

In certain other embodiments of the present disclosure, the at least one compound which is capable of reacting with either the first monomer or the second monomer to form an ester includes a multifunctional alcohol selected from the group consisting of pentaerythritol, glycerine, 1,3-propanediol, 1,4-butanediol, 1,6-hexanediol, trimethyolpropane, dendritic polyols having up to 16 hydroxyl groups, dipentaerythritol, and mixtures thereof.

In one embodiment of the present disclosure, the at least one compound which is capable of reacting with either the first monomer or the second monomer to form an ester preferably includes a polymer, such as a polyvinyl alcohol or a polyacrylic acid.

In another embodiment of the present disclosure, the at least one compound which is capable of reacting with either the first monomer or the second monomer to form an ester preferably includes pentaerythritol.

In still another embodiment of the present disclosure, the at least one compound which is capable of reacting with either the first monomer or the second monomer to form an ester preferably includes a multifunctional carboxylic acid selected from the group consisting of adipic acid, succinic acid, sebacic acid, and mixtures thereof.

In yet another embodiment of the present disclosure, the at least one compound which is capable of reacting with either the first monomer or the second monomer to form an ester preferably includes a cyclic anhydride that yields a multifunctional carboxylic acid selected from the group consisting of trimellitic anhydride, pyromellitic anhydride, and mixtures thereof.

According to certain embodiments of the present disclosure, the degradable copolymer preferably has a number average molecular weight of from about 3000 to about 22,000. In certain embodiments, it is also preferred that the degradable copolymer has a polydispersity index of from about 1.0 up to about 3.0.

Acid Fracture

In a further aspect, the present disclosure also provides a method for acid fracturing of a subterranean rock formation adjacent a well borehole. According to one embodiment, the method includes a first step of mixing solid pellets with a pumpable fluid. The solid pellets are made up of at least one degradable polymer. The fluid and the solid pellets mixed therein are pumped down the borehole and into the rock formation. The degradable polymer then partially depolymerizes into a viscous liquid having a viscosity of from about 1 to about 200,000 centipoise. Pressure is applied to the viscous liquid within the well borehole which is sufficient to induce fracturing of the adjacent rock formation and force the viscous liquid into the resultant fractures. The viscous liquid then further depolymerizes into water-soluble components. These water-soluble components include acidic monomers having a pKa from about 3.1 to about 4.8 which react with, and thereby etch, at least a portion of the rock formation.

According to certain embodiments of the present disclosure, the at least one degradable polymer is a solid when maintained under substantially dry conditions at a temperature of up to about 90 degrees C. When the degradable polymer is contacted with water at a temperature of up to about 90 degrees C., the degradable polymer initially remains solid for a period of up to about 6 to about 24 hours, then depolymerizes to provide a liquid having a viscosity of from about 1 to about 200,000 centipoise after a period of time from about 8 hours to about 3 days and then further depolymerizes to water-soluble components after a period of time at least about 3 days.

According to certain embodiments of the present disclosure, the at least one degradable polymer preferably includes: (1) from about 20 to about 80 mole percent monomer residues of a first monomer selected from the group consisting of L-lactic acid, D-lactic acid, L-lactide, D-lactide, and glycolic acid; (2) from about 20 to about 80 mole percent monomer residues of a second monomer, which is different from the first monomer, selected from the group consisting of L-lactic acid, D-lactic acid, L-lactide, D-lactide, and glycolic acid; and (3) from about 0.001 to about 32 mole percent monomer residues of at least one compound which is capable of reacting with either the first monomer or the second monomer to form an ester.

In some embodiments of the present disclosure, the at least one compound which is capable of reacting with either the first monomer or the second monomer to form an ester preferably is selected from the group consisting of (i) a monofunctional or multifunctional alcohol; (ii) a monofunctional or multifunctional carboxylic acid; (iii) an anhydride that yields a monofunctional or multifunctional carboxylic acid upon reaction of the anhydride; and (iv) a monofunctional or multifunctional epoxide.

In certain embodiments of the present disclosure, the first monomer is preferably L-lactic acid, and the second monomer is glycolic acid. The degradable polymer preferably includes from about 70 to about 80 mole percent monomer residues of the first monomer and from about 20 to about 30 mole percent monomer residues of the second monomer.

In certain other embodiments of the present disclosure, the first monomer is preferably L-lactic acid, and the second monomer is D-lactic acid. The degradable polymer preferably includes from about 70 to about 80 mole percent monomer residues of the first monomer and from about 20 to about 30 mole percent monomer residues of the second monomer.

In still other embodiments of the present disclosure, the first monomer is preferably L-lactide, and the second monomer is D-lactide. The degradable polymer preferably includes from about 50 to about 99.5 mole percent monomer residues of the first monomer and from about 0.5 to about 50 mole percent monomer residues of the second monomer.

According to some embodiments, the composition may also include up to about 5 weight percent of polylactic acid having a number average molecular weight of greater than about 25,000.

In certain other embodiments of the present disclosure, the at least one compound which is capable of reacting with either the first monomer or the second monomer to form an ester is preferably selected from the group consisting of (i) a monofunctional or multifunctional alcohol having from 1 to 16 hydroxyl groups; (ii) a monofunctional or multifunctional carboxylic acid having from 1 to 16 carboxylic acid groups; (iii) and an anhydride that yields a monofunctional or multifunctional carboxylic acid having from 2 to 16 carboxylic acid groups upon reaction of the anhydride.

In certain other embodiments of the present disclosure, the at least one compound which is capable of reacting with either the first monomer or the second monomer to form an ester includes a multifunctional alcohol selected from the group consisting of pentaerythritol, glycerine, 1,3-propanediol, 1,4-butanediol, 1,6-hexanediol, trimethyolpropane, dendritic polyols having up to 16 hydroxyl groups, dipentaerythritol, and mixtures thereof.

In one embodiment of the present disclosure, the at least one compound which is capable of reacting with either the first monomer or the second monomer to form an ester preferably includes a polymer, such as a polyvinyl alcohol or a polyacrylic acid.

In another embodiment of the present disclosure, the at least one compound which is capable of reacting with either the first monomer or the second monomer to form an ester preferably includes pentaerythritol.

In still another embodiment of the present disclosure, the at least one compound which is capable of reacting with either the first monomer or the second monomer to form an ester preferably includes a multifunctional carboxylic acid selected from the group consisting of adipic acid, succinic acid, sebacic acid, and mixtures thereof.

In yet another embodiment of the present disclosure, the at least one compound which is capable of reacting with either the first monomer or the second monomer to form an ester preferably includes a cyclic anhydride that yields a multifunctional carboxylic acid selected from the group consisting of trimellitic anhydride, pyromellitic anhydride, and mixtures thereof.

According to certain embodiments of the present disclosure, the degradable copolymer preferably has a number average molecular weight of from about 3000 to about 22,000. In certain embodiments, it is also preferred that the degradable copolymer has a polydispersity index of from about 1.0 up to about 3.0.

### DETAILED DESCRIPTION

The present disclosure provides a novel class of degradable polymers and a composition which includes at least one such degradable polymer. Compositions made from the degradable polymers are solid and may be used to fabricate tools and various other useful articles. After exposure to an appropriate combination of heat and moisture, however, the degradable polymers will substantially depolymerize, first to a viscous liquid form, and finally to water soluble components. In particular, the degradable polymer is a solid when maintained under substantially dry conditions at a temperature of up to about 90 degrees C. When the degradable polymer is contacted with water at a temperature of up to about 90 degrees C., on the other hand, the degradable polymer initially remains solid for a period of up to about 6 to about 24 hours, then depolymerizes to provide a liquid having a viscosity of from about 1 to about 200,000 centipoise after a period of time from about 8 hours to about 3 days and then further depolymerizes to water-soluble components after a period of time at least about 3 days.

This degradation process or pathway of the present disclosure stands in contrast to prior art polymers which are only said to decompose, if at all, at much higher and impractical temperatures, well over 100 degrees C. The polymers of the present disclosure decompose at substantially lower temperatures.

Moreover, the degradable polymers of the present disclosure decompose into water-soluble components while leaving substantially no solid residue. Preferably, the amount of solid residue left after the polymers decompose is no more than about 1% of the initial mass of the degradable polymers, more preferably not more than about 0.2% of the initial mass.

In contrast, earlier commercially available polymers either do not decompose at all or else, they are observed to primarily decompose into grainy, abrasive solid particles rather than water-soluble components.

The moisture and temperature conditions in which the degradable polymers depolymerize correspond to the conditions typically found in subterranean petroleum extraction wells. Accordingly, compositions made from the degradable polymers of the present disclosure are particularly useful for the fabrication of temporary downhole tools, coatings for sand control devices, and fracture polymers, all of which may be used in petroleum extraction wells

In general, the degradable polymer of the present disclosure includes monomer residues of at least three different types of monomers. The first monomer is preferably selected from the group consisting of L-lactic acid, D-lactic acid, L-lactide, D-lactide, and glycolic acid. The second monomer is also preferably selected from the group consisting of L-lactic acid, D-lactic acid, L-lactide, D-lactide, and glycolic acid; however, the second monomer is selected so as to be different from the first monomer. The third type of monomer included in the degradable polymer is a compound which is capable of reacting with either the first monomer or the second monomer to form an ester.

L-lactic acid, D-lactic acid, and glycolic acid are each hydroxyacids, that is, compounds having both a carboxylic acid group and a hydroxyl group. L-lactide and D-lactide are dimers of L-lactic acid and D-lactic acid, respectively. Thus, these compounds may each be polymerized with one another to form polyesters.

The degradable polymer is preferably composed of (1) from about 20 to about 80 mole percent monomer residues of the first monomer; (2) from about 20 to about 80 mole percent monomer residues of the second; and (3) from about 0.001 to about 32 mole percent monomer residues of the third monomer.

For instance, in one embodiment, the degradable polymer may be composed of from about 70 to about 80 mole percent monomer residues of L-lactic acid and from about 20 to about 30 mole percent monomer residues of glycolic acid.

In a second embodiment, the degradable polymer may be composed of from about 70 to about 80 mole percent monomer residues of L-lactic acid and from about 20 to about 30 mole percent monomer residues of D-lactic acid.

In a third embodiment, the degradable polymer may be composed of from about 50 to about 99.5 mole percent monomer residues of L-lactide and from about 0.5 to about 50 mole percent monomer residues of D-lactide.

As noted above, the degradable polymer also includes monomer residues of at least one compound which is capable of reacting with either the first monomer or the second monomer to form an ester. That is, the third monomer provides either (1) one or more carboxylic acid groups; or (2) one or more hydroxyl groups. However, the third monomer is a compound which does not provide both a carboxylic acid group and a hydroxyl group.

In certain embodiments, this ester-forming compound may be selected from the group consisting of (i) a monofunctional or multifunctional alcohol; (ii) a monofunctional or multifunctional carboxylic acid; (iii) an anhydride that yields a monofunctional or multifunctional carboxylic acid upon reaction of the anhydride; and (iv) a monofunctional or multifunctional epoxide.

More particularly, the ester-forming compound may be selected from the group consisting of (i) a monofunctional or multifunctional alcohol having from 1 to 16 hydroxyl groups; (ii) a monofunctional or multifunctional carboxylic acid having from 1 to 16 carboxylic acid groups; (iii) and an anhydride that yields a monofunctional or multifunctional carboxylic acid having from 2 to 16 carboxylic acid groups upon reaction of the anhydride.

For instance, in certain embodiments, the ester-forming compound may be a multifunctional alcohol selected from the group consisting of pentaerythritol, glycerine, 1,3-propanediol, 1,4-butanediol, 1,6-hexanediol, trimethyolpropane, dendritic polyols having up to 16 hydroxyl groups, dipentaerythritol, and mixtures thereof. Pentaerythritol is particularly preferred multifunctional alcohol.

In certain other embodiments, the ester-forming compound may be a polymer, such as a polyvinyl alcohol or a polyacrylic acid.

In other embodiments, the ester-forming compound may a multifunctional carboxylic acid selected from the group consisting of adipic acid, succinic acid, sebacic acid, and mixtures thereof.

In still other embodiments, the ester-forming compound may be a cyclic anhydride that yields a multifunctional carboxylic acid selected from the group consisting of trimellitic anhydride, pyromellitic anhydride, and mixtures thereof.

Without being bound by theory, it is believed that the ester-forming compounds described above act as a central core from which the polymers grow outward. The concentration of the ester forming compound thereby dictates the number of monomeric units which can be attached to each one before all of the available monomer is consumed. Thus, inclusion of a controlled but relatively small amount of an ester-forming compound, allows for improved control of the ultimate molecular weight of the degradable polymer. Improved control of the polydispersity index of the degradable polymer may also be achieved.

In this regard, according to certain embodiments of the present disclosure, the degradable copolymer preferably has a number average molecular weight of from about 3000 to about 22,000. In certain embodiments, it is also preferred that the degradable copolymer has a polydispersity index of from about 1.0 up to about 3.0.

According to some embodiments, the composition may also include up to about 5 weight percent of polylactic acid having a number average molecular weight of greater than about 25,000.

As noted above, the degradable polymers of the present disclosure, and compositions including such degradable polymers, may be used in a variety of downhole applications in subterranean petroleum extraction wells.

For instance, in one embodiment, a fluid diverter may be fabricated in whole or in part from the degradable polymers of the present disclosure. Other downhole tools such as valves and/or plug may also be fabricated in whole or in part from the degradable polymers of the present disclosure. The degradable tools, or portions thereof, may be fabricated from the degradable polymer by injection molding, casting, extrusion, and other methods.

The degradable downhole tools of the present disclosure may be inserted into a wellbore and used for a temporary purpose therein. Thereafter, the polymer, and the tool formed therefrom, degrades into water-soluble components, leaving an unobstructed wellbore.

In addition, the degradable polymers of the present disclosure may be used to provide a temporary coating over a perforated screen or liner when the screen is initially installed within the wellbore. Perforated screens or liners are typically installed within petroleum wellbores in order to filter out a portion of the sand and other particulates which would otherwise be entrained within the petroleum product as it is extracted from the well. Such sand screens are typically formed from stainless steel mesh having a mesh size of from about 0.01 to about 0.1 inches. In order to effectively filter out particulates once the well is in operation, it is important that the mesh of the sand screen does not become plugged or clogged when the screen is initially placed within the well.

According to the present disclosure, clogging of the sand screen may be prevented by application of a temporary coating of the degradable polymer. The degradable polymer may be heated to a substantially molten state and then coating of the polymer may be applied to the sand screen, such as by dipping or spray coating. The coating is then allowed to cool and re-solidify. While this coating operation may be carried out at ambient room conditions, care is preferably taken to eliminate unnecessary exposure of the coating to moisture.

The coated sand screen is then positioned in the subterranean well hole in a conventional manner. During this initial installation, the polymer coating remains intact over the mesh openings and prevents sand and debris from clogging the mesh. Once the screen is positioned within the well, however, the polymeric coating is then exposed to the environmental conditions within the wellbore. Typically, the temperature within the wellbore will range from about 50 degrees C. to about 90 degrees C. In addition, any materials within the wellbore will be exposed to moisture, in the form of groundwater, on a substantially continuous basis.

The aforementioned environmental conditions are sufficient to cause the degradable polymer coating to begin to depolymerize. Thus, the initially-solid coating of degradable polymer depolymerizes within the wellbore to provide a liquid having a viscosity of from about 1 to about 200,000 centipoise after a period of time from about 8 hours to about 3 days. The viscous liquid then further depolymerizes to water-soluble components after a period of time at least about 3 days. Within a few days after initial installation within the wellbore, the degradable polymer coating is therefore converted to water-soluble degradation products which are readily diluted and diffused by groundwater by groundwater thereby removing the coating from the perforated sand screen or liner. The sand screen is thus advantageously installed within the well without clogging or plugging of the screen mesh.

In another instance, the degradable polymer of the present disclosure may be utilized in a method for hydraulic fracturing of a subterranean rock formation adjacent a well borehole in order to increase the permeability of the rock formation and facilitate extraction of the petroleum via the wellbore.

According to this method, the degradable polymer is mixed with a proppant material, and this mixture is then formed into solid pellets. In a preferred embodiment, the degradable polymer is heated to a substantially molten state and mixed with the proppant using an auger. The resultant mixture is formed into pellets by a pastillation process. The solid pastilles or pellets formed by this process generally range from about 0.125 inch to about 0.25 inch in diameter. The composition of the pellets is generally from about 55 to about 73 weight percent of the degradable polymer and from about 27 to about 45 weigh percent of the proppant. Preferred proppant materials include sand and sintered clay. The average particle size of the proppant is generally from about 20 mesh to about 40 mesh.

Alternatively, solid pellets of the degradable polymer/proppant mixture may be formed by other means such as extrusion. Forming methods such as extrusion may be less desirable, however, due to the abrasiveness of the proppant material and the wear and damage which the proppant may cause within the extrusion equipment.

The solid pellets are then mixed with a pumpable fluid such as water, and the fluid and the solid pellets mixed therein are pumped down the borehole and into the rock formation. Once exposed to the heat and moisture levels within the well, the degradable polymer of the pellets beings to partially depolymerize into a viscous liquid after a time period of from about 6 to about 24 hours. The viscous liquid typically has a viscosity of from about 1 to about 200,000 centipoise. The proppant is dispersed within this viscous liquid.

At this point, hydraulic pressure is then applied to the viscous liquid within the well borehole using a cavity pump. The hydraulic pressure applied sufficient to induce fracturing of the adjacent rock formation. The application of this elevated pressure also forces both the viscous liquid and proppant dispersed therein into the fractures created within the rock formation.

Once the viscous liquid and proppant have been forced into the fractures formed in the rock formation, the viscous liquid then further depolymerizes, first into a thinner liquid, and eventually into water-soluble fragments and monomers. These materials are readily diluted and diffused away by groundwater while leaving the proppant in place within the rock fractures.

In addition to hydraulic fracturing, the degradable polymer of the present disclosure may also be used in acid fracturing of subterranean rock formations. Acid fracturing is particularly useful in the preparation of subterranean rock formations having a high concentration of carbonates and similar minerals which may be dissolved in acidic solution.

According to this method, the degradable polymer is also formed into solid pellets as in hydraulic fracturing. Unlike hydraulic fracturing, however, it is not necessary that the solid pellets include a proppant material, along with the degradable polymer.

Similarly to hydraulic fracturing, the solid pellets are mixed with a pumpable fluid such as water, and the fluid and solid pellets are pumped down the borehole and into the rock formation. Once exposed to the heat and moisture levels within the well, the degradable polymer of the pellets beings to partially depolymerize into a viscous liquid after a time period of from about 6 to about 24 hours. The viscous liquid typically has a viscosity of from about 1 to about 200,000 centipoise. The proppant is dispersed within this viscous liquid.

At this point, hydraulic pressure is then applied to the viscous liquid within the well borehole using a cavity pump. The hydraulic pressure applied is sufficient to induce fracturing of the adjacent rock formation. The application of this elevated pressure also forces both the viscous liquid into the fractures created within the rock formation.

Once the viscous liquid has been forced into the fractures formed in the rock formation, the viscous liquid then further depolymerizes into water-soluble components. Due to the acidic nature of the monomers originally used to form the degradable polymer, these water-soluble components are also acidic in nature and typically include acidic monomers having a pKa from about 3.1 to about 4.8. The presence of these acidic monomer in the fractures etches at least a portion of the rock formation thereby increasing the permeability of the rock formation to petroleum and facilitating extraction of the petroleum via the wellbore.

### Example 1

### Preparation of Degradable Lactic Acid-Glycolic Acid-Pentaerythritol Terpolymers by Condensation Reaction

A two liter pear-shaped flask was charged with 971 grams of an 88 weight percent solution of L (+)-lactic acid (855 grams dry basis) from PURAC, 381 grams of a 70 weight percent solution of glycolic acid (267 grams dry basis) from DuPont, and 4.4 grams of pentaerythritol from Perstorp. As a catalyst, 1.36 grams of tin (II) octoate from Alfa Aesar was also included. The flask was placed on a rotating evaporator and heated to a temperature of about 180° C. at 50-75 rpm and atmospheric pressure. At a temperature of about 160° C., water began to distill from the reaction flask and was collected in the receiving flask of the rotating evaporator.

After a period of about 2-3 hrs, about 40% of the total water was collected in the receiving flask. At this time, a vacuum was applied to the reaction mixture. The pressure was reduced in a stepwise fashion (a reduction of about 100 Torr every 30 minutes) over a 2-3 hour period. When a pressure of about 50-75 Ton was reached, and the reaction mixture produced no more water, the temperature of the reaction mixture was raised to 190° C. The flask was heated for an additional 8-10 hours for a total reaction time of approximately 12-16 hours. During this period, traces of lactide accumulated in the condenser and the reaction mixture was observed to increase in viscosity. The reaction was considered complete and stopped when: (1) the viscosity of a sample measured 4,000-10,000 cps @ 127° C. and (2) the content of volatile materials in the product (as determine by gravimetric loss of a sample heated to 180° C. for 3 minutes) was <0.18 weight percent. The final polymer was observed to be a brownish red, brittle solid and to have a ring and ball softening point of about 72° C.

### Example 2

### Preparation of Degradable D-Lactide-L-Lactide-1,4-Butandiol Terpolymers by Ring Opening Polymerization

A one liter pear-shaped flask was charged with 68.4 grams of L (+)-lactide (PURAC) and 3.6 grams of D (−)-lactide (PURAC). The flask was placed on a rotating evaporator fitted with a gas inlet tube and rotated at about 50 rpm. Dry nitrogen gas was slowly bubbled through the mixture at a rate of approximately 0.01 cubic feet per minute (cfm), and the temperature of the mixture was gradually raised to about 120° C. After about 0.5 hour, the lactide mixture had melted and 1.13 grams of 1,4-butandiol (BASF) was added, along with 34 mg of tin (II) octoate catalyst. The temperature of the reaction mixture was then raised to about 170° C., and the rotational speed of the flask was increased to about 75-100 rpm. Soon after the butanediol and tin catalyst were added, the viscosity of the mixture was observed to increase markedly. Heating was continued for about an additional hour or until samples subjected to infrared spectroscopy showed that disappearance of peaks associated with lactide (1,240 cm⁻¹ C—C—O stretch; 1,055 cm⁻¹ C—O—C stretch; 935 cm⁻¹ C—O stretch). The final polymer was observed to be a clear, brittle solid with a melting point of about 97° C.

### Example 3

### Preparation of Degradable D-Lactic Acid-L-Lactic Acid-1,4-Butandiol Terpolymers by Condensation Reaction

A one liter pear-shaped flask was charged with 430 grams of an 88 weight percent solution of L-lactic acid (378 grams dry basis) from PURAC, 180 grams of a 90 weight percent solution of D-Lactic acid (162 grams dry basis) from PURAC, and 5.4 grams of 1,4-butandiol from BASF. As a catalyst, 0.53 grams of tin (II) octoate from Alfa Aesar was also included. The flask was placed on a rotating evaporator and heated to a temperature of about 180° C. at 50-75 rpm and atmospheric pressure. At a temperature of about 160° C., water began to distill from the reaction flask and was collected in the receiving flask of the rotating evaporator.

After a period of about 2-3 hrs, about 40% of the total water was collected in the receiving flask. At this time, a vacuum was applied to the reaction mixture. The pressure was reduced in a stepwise fashion (a reduction of about 100 Torr every 30 minutes) over a 2-3 hour period. When a pressure of about 50-75 Ton was reached, and the reaction mixture produced no more water, the temperature of the reaction mixture was raised to 190° C. The flask was heated for an additional 8-10 hours for a total reaction time of approximately 12-16 hours. During this period, traces of lactide accumulated in the condenser and the reaction mixture was observed to increase in viscosity. The reaction was considered complete and stopped when: (1) the viscosity of a sample measured 1,000-2,000 cps @ 127° C. and (2) the content of volatile materials in the product (as determine by gravimetric loss of a sample heated to 180° C. for 3 minutes) was <0.18 weight percent. The final polymer was observed to be an amber colored brittle solid and to have a melting point of about 65° C.

### Example 4

### Degradation Rate and Viscosity

In this Example, the degradation properties of the terpolymer of Example 1 were compared to three commercially available polylactic acid (PLA) compositions: (1) PLA 8300D, (2) PLA 4042D, and (3) PLA 3251 D, all from Natureworks LLC.

For each of the four polymers, a solid sample was initially weighed. The samples were then each placed in separate vials containing an excess of water. The vials were then heated to approximately 82° C. and held at that temperature for about 72 hours (3 days) in order to simulate the expected conditions in an underground wellbore. Periodically, the solid sample was reweighed. Any changes (loss) in the sample weight indicate the amount of initially-solid polymer which has depolymerized to a liquid degradation product. When applicable, the viscosity of the liquid degradation product was measured as well. The measured data are shown in the following tables:

| Polymer | 4 hrs | 11 hrs | 24 hrs | 48 hrs | 72 hrs |
|---|---|---|---|---|---|
| | Sample Percent Weight Loss | | | | |
| Example 1 | 0 | 0 | 12 | 91 | 100 |
| PLA 8300D | 0 | 0 | 0 | 0 | 10 |
| PLA 4042D | 0 | 0 | 0 | 0 | 2 |
| PLA 3251D | 0 | 0 | 0 | 0 | 0 |
| | Liquid Viscosity (cps) | | | | |
| Example 1 | 11,700 | 880 | 420 | <200 | no residue |
| PLA 8300D | N/A | N/A | N/A | N/A (solid) | N/A (solid) |
| | (solid) | (solid) | (solid) | | |
| PLA 4042D | N/A | N/A | N/A | N/A (solid) | N/A (solid) |
| | (solid) | (solid) | (solid) | | |
| PLA 3251D | N/A | N/A | N/A | N/A (solid) | N/A (solid) |
| | (solid) | (solid) | (solid) | | |

The above data demonstrates that the polymer of Example 1 degrades from an initial solid state into a viscous liquid stage in just a matter of hours and then becomes a very thin liquid within about 48 hours. After about 72 hours, the polymer of Example 1 has degraded to completely water soluble materials leaving behind no solid residue.

On the other hand, all three of the commercial PLAs degraded only by slow dissolution from a solid state. The most amorphous PLA grade of the three shown (PLA 8300D) showed only a 10% loss of its initial mass after three days at 82° C. while the most crystalline of the PLA grades (PLA 3251D) show no measurable degradation at all after three days at 82° C. None of the three commercial PLAs was observed to degrade into a viscous liquid or into water soluble liquid components with no solid residue.

These results are particularly notable since certain prior art references such as U.S. Pat. No. 7,166,560 suggest that commercial PLA resins such as PLA 4042D will rapidly disintegrate at temperatures in the range of about 149° C. Such extreme temperatures are rarely encountered in actual oilfield wellbores, however, with temperatures in the range of about 40-88° C. being much more typical in the field. At these more representative temperatures, the above results demonstrate that commercially available PLAs degrade much more slowly, if they degrade at all.

### Example 5

### Effect of Composition on Degradation Pathway (Liquid vs. Solid)

In this example, samples of polymers of L-lactic acid, glycolic acid, and pentaerythritol were prepared. The mole percentages of L-lactic acid and glycolic acid were varied as shown in the following table. Each of the samples also included 0.25 mole percent pentaerythritol. These samples were then heated to a temperature of about 60° C. in the presence of water and allowed to depolymerize. After depolymerizing, the physical state (liquid or solid) of the resultant degradation products was observed and recorded. The results were as follows:

| Mole % of | | |
|---|---|---|
| L-Lactic Acid | Mole % of Glycolic Acid | Physical State of |
| Monomer Units | Monomer Units | Degradation Products |
| 100 | 0 | Solid |
| 85 | 15 | Solid |
| 80 | 20 | Solid |
| 78 | 22 | Solid |
| 75 | 25 | Liquid |
| 73 | 27 | Liquid |
| 70 | 30 | Liquid |

Similarly, samples of polymers of L-lactic acid, D-lactic acid, and pentaerythritol were prepared. The mole percentages of L-lactic acid and D-lactic acid were varied as shown in the following table. Each of the samples also included 0.25 mole percent pentaerythritol. These samples were also heated to a temperature of about 60° C. in the presence of water and allowed to depolymerize. After depolymerizing, the physical state (liquid or solid) of the resultant degradation products was observed and recorded. The results were as follows:

| Mole % of | | |
|---|---|---|
| L-Lactic Acid | Mole % of D-Lactic Acid | Physical State of |
| Monomer Units | Monomer Units | Degradation Products |
| 100 | 0 | Solid |
| 85 | 15 | Solid |
| 70 | 30 | Liquid |
| 50 | 50 | Liquid |

These results demonstrate that the proportion or ratio of L-lactic acid to glycolic acid (or L-lactic acid to D-lactic acid)-has a profound effect on the final physical state of the polymer as it is hydrolytically degraded. When the ratio of L-lactic acid to the second monomer (either glycolic acid or D-lactic acid) is relatively high, the polymer turns into solid particulates as it degrades. As the ratio of L-lactic acid to the second monomer become smaller, however, it is observed that the degradation proceeds through a viscous liquid stage and not through a particulate solid stage.

For both L-lactic acid polymerized with glycolic acid and D-lactic acid, the change in phase from solid to liquid occurs at similar mole percentages (about 25% for glycolic acid and about 30% for D-lactic acid). Without being bound by theory, it is believed that at these mole percentages, the amount of the second monomer ((either glycolic acid or D-lactic acid) is sufficient to significantly disrupt the crystalline structure of the first monomer (L-lactic acid). This in turn is believed to increase the amorphous character of the polymer, thus making it more susceptible to hydrolytic degradation.

In a further test, samples of degradable polymers made from L-lactic acid, glycolic acid, and pentaerythritol were prepared and then degraded at two different temperatures (60° C. and 82° C.) to observe the effect of temperature on the nature of the degradation products. The results are summarized in the following table:

| Mole % of | | | |
|---|---|---|---|
| L-Lactic | Mole % of Glycolic | | Physical State of |
| Acid Monomer | Acid Monomer | Degradation | Degradation |
| Units | Units | Temperature | Products |
| 78 | 22 | 60° C. | Solid |
| 78 | 22 | 82° C. | Liquid |

These results demonstrate that the nature of the degradation products (i.e., the degradation pathway) is dependant upon both the composition of the polymer and the temperature at which the polymer is depolymerized.

### Example 6

### Extended Study of Degradation Rate and Viscosity

In this Example, the degradable polymers of Examples 1 and 2 were blended. The blend included about 88 weight percent of the terpolymer of Example 1 and about 12 weight percent of the copolymer of Example 2. The degradation properties of the blend were studied for an extended period lasting about 15 days. A solid sample of the polymer was initially weighed. The sample was then each placed in a vial containing an excess of water, and the vial was heated to approximately 88° C. and held at that temperature for a total of 371 hours (15 days) in order to simulate the expected conditions in an underground wellbore. Periodically, the solid sample was reweighed. Any losses in the sample weight indicate the amount of initially-solid polymer which has depolymerized to a liquid degradation product. When applicable, the viscosity of the liquid degradation product was measured as well. The measured data are shown in the following table:

| Time | Mass (Percentage of | Viscosity (cps) |
|---|---|---|
| (hours) | Initial Mass) | at 88 degrees C |
| 1.5 | 104 | N/A (solid) |
| 7.5 | 106 | N/A (solid) |
| 11.5 | 104 | N/A (solid) |
| 19.5 | 103 | N/A (solid) |
| 23.5 | 94 | 72,500 |
| 26 | 85 | 1,360 |
| 33.5 | 65 | 2,825 |
| 35.5 | 61 | 1,918 |
| 36.5 | 56 | 2,512 |
| 40 | 51 | 1,208 |
| 49 | 34 | <200 |
| 54 | 23 | <200 |
| 62 | 20 | <200 |
| 70 | 16 | <200 |
| 91 | 13 | <200 |
| 107 | 11 | <200 |
| 149 | 6 | <200 |
| 245 | 4 | <200 |
| 371 | 0.2 | <200 |

The small initial increase in mass observed during the first day of the testing is believed to be due to adsorption of moisture by the initially-solid polymer blend.

### Example 7

### Preparation of Polymer/Proppant Pastilles

In this example, pastilles of degradable polymer containing proppant were produced using a Sandvik Rotoform pastillator. The degradable polymer heated to a temperature of about 160° C. and then pumped as a melt to an auger system. Proppant was also gravimetrically fed to the auger. In one test, the proppant was sand which had been classified using a 20 to 40 mesh screen (0.45-0.48 mm diameter). In a second test, the proppant was a sintered clay (ECONOPROP, available from CarboCeramics). The proppants were mixed with the polymer in the auger at a target rate of about 27 to about 45 weight percent. The mixture was then pumped to the rotoform head of the pastillator. The pastillator head temperature was set at 177° C. and the head rotated at 22 rpm.

The pastilles were expressed from the rotoform head onto a moving stainless steel belt that was cooled by means of chilled water from below the belt to about 16° C. The belt speed was about 30 feet per minute (fpm), and the pastilles were doctored off the end of the belt into containers and stored in fiber drums. The average diameter of the pastilles formed ranged from about 0.125 inch to about 0.25 inch.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A composition comprising at least one degradable polymer,
wherein the degradable polymer is a solid when maintained under substantially dry conditions at a temperature of up to about 90 degrees C., and
where the degradable polymer, when contacted with water at a temperature of up to about 90 degrees C., initially remains solid for a period of up to about 6 to about 24 hours, then depolymerizes to provide a liquid having a viscosity of from about 1 to about 200,000 centipoise after a period of time from about 8 hours to about 3 days and then further depolymerizes to water-soluble components after a period of time at least about 3 days.

2. The composition of claim 1, wherein the at least one degradable polymer comprises:
from about 20 to about 80 mole percent monomer residues of a first monomer selected from the group consisting of L-lactic acid, D-lactic acid, L-lactide, D-lactide, and glycolic acid;
from about 20 to about 80 mole percent monomer residues of a second monomer, which is different from the first monomer, selected from the group consisting of L-lactic acid, D-lactic acid, L-lactide, D-lactide, and glycolic acid; and
from about 0.001 to about 32 mole percent monomer residues of at least one compound which is capable of reacting with either the first monomer or the second monomer to form an ester.

3. The composition of claim 2, wherein the at least one compound which is capable of reacting with either the first monomer or the second monomer to form an ester is selected from the group consisting of (i) a monofunctional or multifunctional alcohol; (ii) a monofunctional or multifunctional carboxylic acid; (iii) an anhydride that yields a monofunctional or multifunctional carboxylic acid upon reaction of the anhydride; and (iv) a monofunctional or multifunctional epoxide.

4. The composition of claim 2, wherein the first monomer is L-lactic acid, the second monomer is glycolic acid and wherein the degradable polymer comprises from about 70 to about 80 mole percent monomer residues of the first monomer and from about 20 to about 30 mole percent monomer residues of the second monomer.

5. The composition of claim 2, wherein the first monomer is L-lactic acid, the second monomer is D-lactic acid and wherein the degradable polymer comprises from about 70 to about 80 mole percent monomer residues of the first monomer and from about 20 to about 30 mole percent monomer residues of the second monomer.

6. The composition of claim 2, wherein the first monomer is L-lactide, the second monomer is D-lactide and wherein the degradable polymer comprises from about 50 to about 99.5 mole percent monomer residues of the first monomer and from about 0.5 to about 50 mole percent monomer residues of the second monomer.

7. The composition of claim 2, wherein the composition further comprises up to about 5 weight percent of polylactic acid having a number average molecular weight of greater than about 25,000.

8. The composition of claim 2, wherein the at least one compound which is capable of reacting with either the first monomer or the second monomer to form an ester is selected from the group consisting of (i) a monofunctional or multifunctional alcohol having from 1 to 16 hydroxyl groups; (ii) a monofunctional or multifunctional carboxylic acid having from 1 to 16 carboxylic acid groups; (iii) and an anhydride that yields a monofunctional or multifunctional carboxylic acid having from 2 to 16 carboxylic acid groups upon reaction of the anhydride.

9. The composition of claim 2, wherein the at least one compound which is capable of reacting with either the first monomer or the second monomer to form an ester comprises a multifunctional alcohol selected from the group consisting of pentaerythritol, glycerine, 1,3-propanediol, 1,4-butanediol, 1,6-hexanediol, trimethyolpropane, dendritic polyols having up to 16 hydroxyl groups, dipentaerythritol, and mixtures thereof.

10. The composition of claim 2, wherein the at least one compound which is capable of reacting with either the first monomer or the second monomer to form an ester comprises a polymer.

11. The composition of claim 2, wherein the at least one compound which is capable of reacting with either the first monomer or the second monomer to form an ester comprises a polyvinyl alcohol.

12. The composition of claim 2, wherein the at least one compound which is capable of reacting with either the first monomer or the second monomer to form an ester comprises a polyacrylic acid.

13. The composition of claim 2, wherein the at least one compound which is capable of reacting with either the first monomer or the second monomer to form an ester comprises pentaerythritol.

14. The composition of claim 2, wherein the at least one compound which is capable of reacting with either the first monomer or the second monomer to form an ester comprises a multifunctional carboxylic acid selected from the group consisting of adipic acid, succinic acid, sebacic acid, and mixtures thereof.

15. The composition of claim 2, wherein the at least one compound which is capable of reacting with either the first monomer or the second monomer to form an ester comprises a cyclic anhydride that yields a multifunctional carboxylic acid selected from the group consisting of trimellitic anhydride, pyromellitic anhydride, and mixtures thereof.

16. The composition of claim 2, wherein the degradable copolymer has a number average molecular weight of from about 3000 to about 22,000.

17. The composition of claim 2, wherein the degradable copolymer has a polydispersity index of from about 1.0 up to about 3.0.

18. A degradable downhole tool for use in a wellbore, wherein the downhole tool comprises the composition of claim 1.

19. A degradable downhole tool for use in a wellbore, wherein the downhole tool comprises the composition of claim 2.

20. The degradable downhole tool of claim 18, wherein the downhole tool comprises a fluid diverter.

21. The degradable downhole tool of claim 18, wherein the downhole tool comprises a valve.

22. The degradable downhole tool of claim 18, wherein the downhole tool comprises a plug.
